(19) United States
(12) Patent Application Publication
(10) Pub. No.: US 2011/0050609 A1
(43) Pub. Date: Mar. 3, 2011

(54) METHOD FOR ENTERING A TWO-DIGIT VALUE AT AN OPERATING DEVICE

(75) Inventor: Henry Fluhrer, Bretten (DE)

(73) Assignee: E.G.O. Elektro-Geraetebau GmbH

(21) Appl. No.: 12/861,886

(22) Filed: Aug. 24, 2010

(30) Foreign Application Priority Data
Aug. 25, 2009 (DE) 10 2009 039 937.2

(51) Int. Cl. G06F 3/041

(52) U.S. Cl. 345/173

(57) ABSTRACT

In a method for setting a two-digit value for a function parameter for a function device at an operating device, the operating device is appropriately designed for operating the function device. It has a sensor operating panel designed to detect and evaluate movements, independently of one another, of a finger in contact in two operating directions perpendicular to one another. Setting of the two-digit value at the operating device is achieved for the units-places by a movement of a finger on the sensor operating panel in a first operating direction. The tens-places are set independently of this by a movement of a finger on the sensor operating panel in a second operating direction.

### CROSS REFERENCE TO RELATED APPLICATIONS

This application claims priority to German Application Number 10 2009 039 937.2 filed on Aug. 25, 2009, the contents of which are incorporated by reference for all that it teaches.

### FIELD OF THE INVENTION

The invention relates to a method for setting a two-digit value for a function parameter for a function device at an operating device for said function device, and to a corresponding operating device. The function device can be, for example, a heating device of a hotplate on an electric hob and the operating device is provided for the electric hob.

### BACKGROUND OF THE INVENTION

It is known from the prior art of U.S. Pat. No. 5,917,165, for example, how to set a power stage of a heating device of a hotplate in an electric hob using two touch switches in the form of plus and minus keys. To run through all the power stages, either one of the touch switches must be actuated very frequently, or alternatively it must be kept pressed down by a finger for some time. This is perceived by the operator to be inconvenient.

As an alternative to this, operating devices with touch sensors in the form of so-called sliders have frequently appeared in recent times. They have an elongated and strip-like sensor operating panel. When they are pressed and stroked by a finger, values for a power setting, for example, can be run through very much faster and more readily visible to an operator.

### SUMMARY OF THE INVENTION

An object underlying the invention is to provide a method of the aforementioned type and a corresponding operating device wherein problems present in the prior art can be avoided and a convenient, intuitive, and rapid operation or setting of a two-digit or multi-digit value is possible.

This problem is solved by a method and operating device having the features as claimed herein. Advantageous and preferred embodiments of the invention form the subject matter of the further claims and are explained in greater detail in the following. Some of the features detailed in the following are cited only for the method or only for the operating device. Regardless of that, however, they should be applicable both for the method and for the operating device. The wording of the claims is made into part of the substance of the description by express reference.

In one embodiment, the operating device has a sensor operating panel. The sensor operating panel is designed to detect and evaluate movements, independently of one another, of a finger in proximity or in contact with the sensor operating panel, in two operating directions substantially perpendicular to one another. For setting of a two-digit value, this is detected in accordance with one embodiment of the invention at the operating device or sensor operating panel by a movement of a finger on the sensor operating panel in a first operating direction, and the “units-places” (i.e., the units digit) of the function value are set accordingly. Input of the “tens-places” (i.e., the tens digit) of the function value is performed independently of this by movement of a finger on the sensor operating panel, the finger again being in proximity or in contact, in a second operating direction. The tens-places can then be set in this way.

The sensor operating panel is advantageously designed in a rectangular manner. To operate, a finger is positioned in proximity or in contact and is, for example, moved to the right. This direction is then taken as the first operating direction, and corresponding to this movement the units-places of a function value are set. If the finger is moved in proximity or in contact in the second operating direction, possibly even before the setting of the units-places, the tens-places are set accordingly. It is thus possible with a single sensor operating panel, and without complicated switching over to another operating mode, to achieve an input or operation in two different ways. Two-digit values for a function parameter such as a power stage, a timer input or other numerical values, can thus be entered very easily, intuitively and quickly.

In another embodiment of the invention, if the sensor operating panel is rectangular, then the first operating direction of the units-places can pass along a longitudinal side of the sensor operating panel, advantageously horizontally or to the right. The second operating direction for the tens-places then runs advantageously vertical thereto, i.e., upwards.

In another embodiment of the invention, it is possible that at a certain time only one digit can be entered, for example only the units-places or only the tens-places. This then means that a movement of a finger in proximity to, or in contact with, the sensor operating panel is taken into account with regard to its movement component only in a single or corresponding operating direction. An oblique movement of a finger can therefore only be evaluated and used with regard to this movement component, which runs relatively precisely along one of the operating directions.

In another embodiment of the invention, certain angular divergences from the operating directions are deemed as still associated with the latter in order to avoid switching between two operating modes. It can therefore be provided, for example, that a movement to the right along the first operating direction does not have to be only exactly to the right, but can also be recognized as such even at a diverging angle of, for example, 20° or 25° or even more. The result of this is sectors, for example extending from the bottom left-hand corner of the sensor operating panel, deemed to be associated with the first operating direction. A movement of the finger in this sector is evaluated as being associated with the first operating direction. As a result, a slightly more tolerant operation can be achieved. The operating directions thus practically flare or fan out.

In yet another embodiment of the invention, a movement of a finger in proximity to or in contact with the sensor operating panel is simultaneously evaluated in respect of its two components in the two operating directions, and then the units-places and the tens-places can be changed according to these directional components. This means therefore that a movement of a finger exclusively in the first operating direction adjusts only the units-places, and exclusively in the second operating direction only the tens-places. An oblique movement with an angle between them however adjusts both at the same time, depending on that angle or on the appropriate direction components. An operator can therefore set a two-digit value very quickly, conveniently, and intuitively by selecting the angle of movement of a finger between the two operating directions.

Generally speaking, it can be advantageously provided that starting from one point, for example front left of the sensor operating panel, movements away from it are evaluated as an increase in the appropriate value and movements toward it as a decrease. Alternatively to an arrangement of this important point, which can be regarded practically as a starting point or reference point, at one corner of the sensor operating panel, it can also be arranged in the centre or in a central area.

The operating device or the sensor operating panel is designed such that any movement of a finger in proximity to, or in contact with, the sensor operating panel or simply a contact point can be detected. The finger therefore does not necessarily have to be moved only in one direction, but the movement can also have a curved or angled course. The respectively counted components of the operating travel are then taken into account in accordance with one of the three previously described embodiments of the invention.

In another embodiment of the invention, only a finger in contact with the sensor operating panel or the movement of this finger is detected. It can then be provided that when a finger is in contact a rearward movement continues to effect an adjustment of the appropriate value in a units-place and/or a tens-place corresponding to the operating direction, and then possibly a decrease. Only removal of the finger practically ends the adjustment of the value, and the value can be adjusted again when the finger is again in contact.

In another embodiment of a method in accordance with the invention, the sensor operating panel detects the touching point of a contacting finger without movement on the sensor operating panel. Assuming the finger would be directly moved from a starting point with a pulling movement, while a finger is in contact the sensor operating panel, towards the latter as a touching distance, the sensor operating panel determines at the touching point the values for the units-places and for the tens-places and sets them, these values corresponding to the touching distance, although only one point has been touching The same result is thus achieved regardless of whether the finger is in contact with the sensor operating panel at the starting point and is then moved to the touching point, or whether the finger is placed directly on the touching point. This corresponds most closely to a sensor operating panel and to an evaluation in accordance with the third variation stated at the outset, in which the components in the respective direction are taken fully into account and evaluated during every movement.

The operating device can have sensors of differing design, wherein advantageously a sensor is arranged at least in every corner area. It is particularly advantageous when several sensors are also provided between them or spread over the surface of the sensor operating panel. Pressure sensors can be used as sensors in one embodiment of the invention, which detect the pressure exerted on the sensor operating panel by the contact of a finger. Piezo sensors or piezo resistive sensors are particularly suitable here. In another embodiment, capacitive sensors can be used, as known for example from the aforementioned U.S. Pat. No. 5,917,165. A covering surface of the sensor operating panel is then advantageously in an designed electrically insulating manner, and is in particular made of glass or plastic.

In yet another embodiment, optical sensors can be used, with a covering surface of the sensor operating panel then being optically translucent. This should apply at least for light in a certain wavelength, which is the operating wavelength of the sensors.

These and further features can be gathered not only from the claims, but also from the description and drawings, wherein the individual features, both singly or severally in the form of subcombinations, can be implemented in an embodiment of the invention and in other fields and can represent advantageous and independently protectable designs for which protection is claimed here. The subdivision of the application into individual sections and the subheadings in no way restricts the general validity of the statements made thereunder.

### BRIEF DESCRIPTION OF THE DRAWINGS

Embodiments of the invention are shown schematically in the drawings and are explained in detail in the following. The drawings show in:

FIG. 1 a plan view onto an operating device in accordance with the invention, showing a first variant of an operating method in accordance with one embodiment of the invention,

FIG. 2 a plan view onto another embodiment of the operating device and operating method similar to FIG. 1,

FIG. 3 a view of another embodiment of an operating device from below and from the side with four pressure sensors at corners of the sensor operating panel, and

FIG. 4 a variation of the view of FIG. 3 with capacitive sensors.

### DETAILED DESCRIPTION OF THE EMBODIMENTS

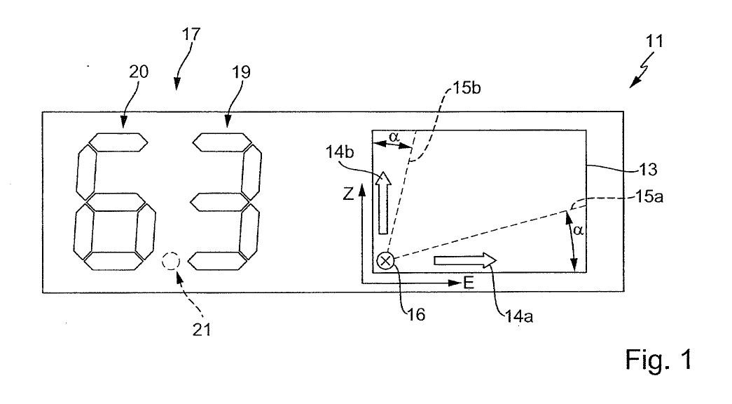

FIG. 1 shows in plan view an operating device 11 in accordance with the invention and designed approximately rectangular and capable of being installed on or in an electrical appliance in order to operate it, for example an extractor hood, a hob, or a cooker. The operating device 11 has in the right-hand area a sensor operating panel 13 of rectangular shape. This can be a part of the rest of the surface of the operating device 11 or have a separate surface, depending on the embodiment and on design considerations. A display 17 is provided in the form of a seven-segment display in the left-hand area of the operating device 11. The two-digit display 17 comprises a units-place 19 and a tens-place 20 that can be separated by a point display shown as a dotted line. The display 17 is obviously intended for displaying a numerical value that can be two-digit. This display 17 can thus display a one or two-digit value for a function parameter of a function device of the electric appliance provided with the operating device 11, said value having been input previously using the sensor operating panel 13. These can be, for example be, various power stages for the fan of an extractor hood, or brightness settings for its lighting system. In the case of a timer usable for any electric appliances, it can be a time in minutes. The two-digit value stated here can even be such that the units-place 19 counts behind the decimal point indicated by the illuminated dot display 21 and the tens-place 20 is the digit in front of the decimal point. Further possible values are power stages on a hotplate of an electric hob.

The display 17 shows here the set value input into a control unit using the sensor operating panel 13. This control unit is easily implemented by the person skilled in the art and is for that reason not shown separately here.

Inside the sensor operating panel 13, there is a first operating direction 14a to the right, corresponding to the direction E. With this first operating direction 14a corresponding to the direction E, the units-place 19 of the value to be input or set can be altered or set. By bringing a finger into proximity to or advantageously into contact with the surface of the sensor operating panel 13 and moving it along the operating direction 14a, the units-place 19 is increased. It can be provided here that in the bottom left-hand corner of the sensor operating panel 13, a starting point 16 is provided, possibly even indicated by a printed symbol. If a finger now contacts this starting point 16 and is then pulled to the right-hand edge of the sensor operating panel 13 in the direction E corresponding to the first operating direction 14a, either the entire width from 0 to 9 can be set at the units-place 19, or, for a finer/different resolution it can be provided that a movement along the entire width of the sensor operating panel 13 only covers three to five digits, meaning that for setting a “9” as the maximum units-place 19 the finger must be moved from the starting point 16 twice all the way to the right along the first operating direction 14a.

Furthermore, a second operating direction 14b along the direction Z is shown, i.e., vertically to the first operating direction 14a. As a result, the tens-place 20 can be set at the display 17 in the appropriate manner described above.

If a movement of a finger is not precisely along the directions E or Z, sector limits 15a and 15b shown in dashed lines can be provided at least functionally and not necessarily visually discernible. These have the significance that a movement of a contacting finger within these sector limits 15 is evaluated as if the movement were taking place precisely in one of the directions E or Z as the operating direction 14. It is therefore possible to achieve a more tolerant and hence easier operation or input of a value. The angle α for the sector limits 15a and 15b can be, for example, the 15° angle as shown, but possibly also more than 25° and even up to 45° . As a result, the sensor operating panel 13 is then split precisely into two parts or sectors, making its operation even more tolerant.

It can also be seen from FIG. 1 that in particular when the sector limits 15a and 15b are provided, only one digit of the value can actually be set at the display 17 at a time, in other words either only the units-place 19 or only the tens-place 20. Although this allows a simple, precise and convenient setting of the value, two movements must take place for both sides.

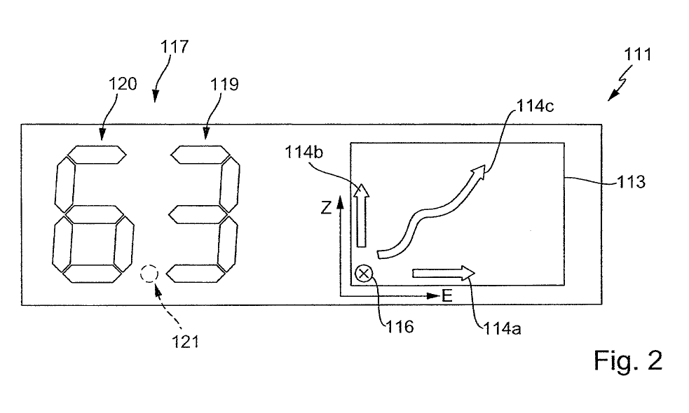

In another embodiment of the invention in accordance with FIG. 2, the setting of the value can be achieved more quickly and in some circumstance even with one movement. This operating device 111 here has an identically constructed sensor operating panel 113 with a first operating direction 114a along a direction E for the units-places and with a second operating direction 114b along a direction Z for the tens-places. A display 117 has, corresponding to FIG. 1, a units-place 119, a tens-place 120 and a point display 121 shown as a dotted line.

It is provided here that a movement of a finger in contact with the sensor operating panel 113 is always split into its operating direction components corresponding to the direction E or to the direction Z, or to the first operating direction 114a or to the second operating direction 114b. Both digits of the display 117 or both digits of the corresponding value are adjusted at the same time here.

This can be made clear based on the operating direction 114c, practically in wavy lines. With this movement, the component in the direction E and the direction Z is evaluated in each case and then altered to match the value shown by the display 117. In a first and steeper part with a larger component in the Z direction, the tens-place 120 is therefore adjusted more strongly than the units-place 119. This is followed by a flatter section such that here in turn it is the units-place 119 which is more strongly adjusted/increased.

The use of the terms “first” and “second” for the operating directions does not relate to the timing of their setting, but to the alignment of these operating directions corresponding to the direction E or the direction Z perpendicular thereto.

For the starting point 16, it can furthermore apply that the latter is placed functionally in the bottom left-hand corner of the sensor operating panel 14 when the value to be set according to display 17 is still zero and can only be increased. Once a certain value has been set, which may have to be reduced in the further course of the operating process, if it is, for example, a power stage of an aforementioned hotplate on a hob, the starting point 16 can also be positioned elsewhere, for example in the middle of the sensor operating panel 13. This has the advantage that from this point both an increase and a reduction are possible.

FIG. 2 also shows that adjustment of only the corresponding units-place 119 or tens-place 120 remains possible by moving a finger precisely along the first or second operating direction 114a or 114b.

In view of the previous statements regarding the increased tolerance by widening with sectors using to the sector limits 15, it can be provided that during any movement on the sensor operating panel 113 not every tiny component in the associated direction is evaluated, but only when it diverges similarly to the sector limit, for example by 10° to 15° or even 20° , from the pure direction E or Z.

In yet another embodiment of the invention, it can also be provided that it is not the longitudinal movement of the finger on the sensor operating panel 113 alone that permits setting of a value, but by placing of the finger relatively far down on the right of the sensor operating panel the units-place 119 is adjusted upwards as strongly as if the finger were being moved to this point by a contacting and pulling movement in a straight direction.

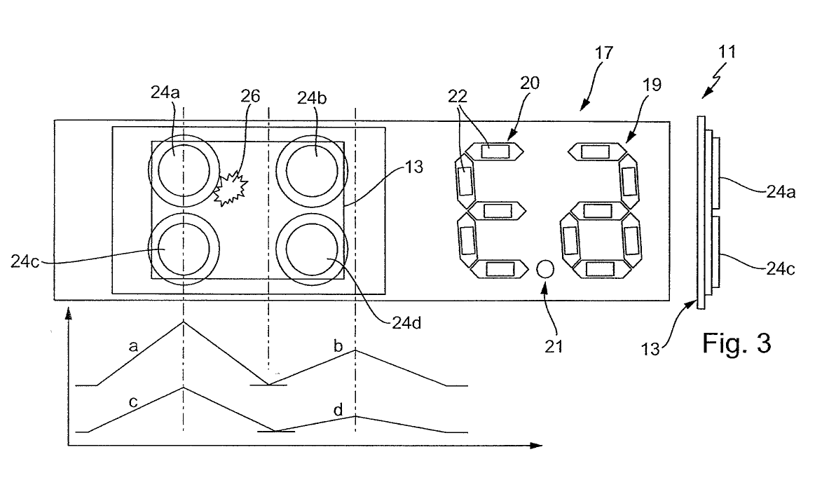

FIG. 3 shows, by a rear view, a sectional view and a diagram for signal amplitude over the touching distance for the operating device 11, how the latter can be structured. In this connection, reference is made to U.S. Patent No. 2010/007531 regarding the mechanical construction with piezo sensors 24a to 24d underneath the sensor operating panel 13. These piezo sensors 24a to 24d are arranged in the four corner areas of the sensor operating panel 13.

If a finger is moved from the starting point 16 to the touching point 26, it is shown in the lower diagram how its position on the sensor operating panel 13 can be detected at this touching point 26 or also at any other touching point. The diagram shows here how the signal amplitude of the piezo sensors 24a to 24d changes accordingly when the touching point 26 is in its vicinity. This therefore means that the approximate position on the sensor operating panel can be ascertained using the ratio of the four individual signal levels at the piezo sensors 24 or of the respective signal amplitude, which is greatest at the piezo sensor 24a and lowest at the piezo sensor 24d. This is however known per se, see for example the aforementioned U.S. Patent 2010/007531. By tracing the touching points 26 starting from the starting point 16, therefore, a line or movement corresponding to an operating direction 14 according to FIG. 1 or 114 according to FIG. 2 can be determined in its time sequence.

Alternatively, it is however also possible within the scope of the invention for only the touching point 26 and an end point of such a movement to be determined. If a finger is therefore placed without a pulling movement on the touching point 26, it is assumed that it has been moved towards it directly from the starting point 16 with a contacting and pulling movement. Values for the units-places and the tens-places are therefore set at the touching point 26 which correspond to the touching distance although only one point has been touched.

It can also be seen in the rear view on FIG. 3 that LEDs 22 for the display 17 are provided with units-places 19, tens-places 20 and the point display 21. This does not need to be explained in detail as it is clear for a person skilled in the art.

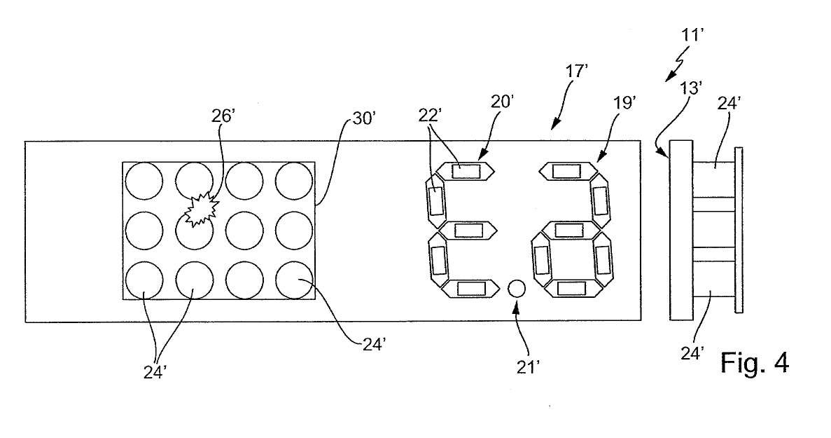

From the variation of an operating device 11′ in accordance with FIG. 4, it can be seen that no piezo sensors are provided here that react to actual pressure and a minor mechanical movement at the sensor operating panel, but twelve capacitive sensor elements 24′. These correspond to the sensor elements from U.S. Pat. No. 5,917,165 cited at the outset, to which reference is made for their function. Hence it is also possible, as shown on the right, for the sensor operating panel 13′ to be designed considerably thicker, for example of glass ceramics for a glass ceramic hob, or of another electrically insulating material. Here too, evaluation is achieved at the touching point 26′ by comparison or by the ratio of the individual signal levels of the various sensor elements 24′. This enables good localization.

It is noteworthy that considerably more capacitive sensor elements 24′ are provided than piezo sensors 24 in accordance with FIG. 3. In other embodiments, a greater number of capacitive sensor elements can be used. This permits the potential for even more precise localization. Furthermore, it takes account of the fact that the local resolution of such capacitive sensors is usually worse than that of piezo sensors.

If the optical sensors mentioned at the outset are used, for example as reflective light barriers, they can usually only cover a relatively narrow area above themselves. Above all, they can also only detect graduations poorly, the crux being that either shadowing takes place or it does not. For that reason, even more of these optical sensors would have to be provided than capacitive sensor elements to achieve a sufficiently high resolution.

1. A method for setting a two-digit value with units-places and tens-places for a function parameter for a function device at an operating device, said operating device configured for operating said function device, wherein said operating device has a sensor operating panel, wherein said sensor operating panel detects and evaluates movements independently of one another of a finger in proximity or in contact in two operating directions being substantially perpendicular to one another, comprising the steps of:
detecting a movement of said finger on said sensor operating panel in a first operating direction and in a second operating direction, wherein said second operating direction is substantially perpendicular to said first operating direction;
setting said units-places value at said operating device based on evaluating said movement of said finger in said first operating direction; and
setting said tens-places value at said operating device independently of said movement of said finger in said first operating direction based on said movement of said finger in said second operating direction.

2. The method according to claim 1, wherein said sensor operating panel is rectangular and said first operating direction passes along a longitudinal side of said sensor operating panel and said second operating direction substantially vertical thereto.

3. The method according to claim 2, wherein said units-places are set based on said horizontal direction as said first operating direction and said tens-places are set in said vertical direction thereto based on said second operating direction.

4. The method according to claim 1, wherein said movement of said finger in contact with said sensor operating panel simultaneously in both two operating directions at an angle obliquely between said two operating directions adjusts only said units-places or only said tens-places at a time with a proportion of said respective appropriate directional component of an overall movement of said finger, wherein only said proportion of that part of said operating directional component corresponding to said operating direction is used.

5. The method according to claim 1, wherein said movement of said finger in contact with said sensor operating panel simultaneously in both two operating directions adjusts only said units-places or only said tens-places at a time with a proportion of said respective appropriate operating directional component of said overall movement of said finger, wherein said proportion of said operating directional component diverging from said operating direction by a diverging angle of up to 25° or up to 40° is used.

6. The method according to claim 1, wherein said movement of said finger in contact with said sensor operating panel simultaneously in both two operating directions adjusts both said units-places and said tens-places with a proportion of said respective operating direction component of an overall movement of said finger.

7. The method according to claim 1, wherein movements away from a point are evaluated as an increase of said appropriate value and movements toward said point are evaluated as a decrease of said appropriate value, such that said point forms a starting point or reference point.

8. The method according to claim 7, wherein the starting point or reference point is at a front left of said sensor operating panel.

9. A method for setting a two-digit value with units-places and tens-places for a function parameter for a function device at an operating device, said operating device configured for operating said function device, wherein said operating device has a sensor operating panel, comprising the steps of:
detecting a touching point of a contacting finger by said sensor operating panel without movement of said contacting finger on said sensor operating panel;
moving said finger from a starting point with a pulling movement while said finger is in contact with said sensor operating panel as a touching distance;
determining by said sensor operating panel values for said units-places and for said tens-places corresponding to said touching distance as a direct and straight-line movement; and
setting said values for said units-places and for said tens-places.

10. An operating device comprising:
a sensor operating panel on an underside area of said operating device;
a plurality of sensors in corner areas of said sensor operating panel for detecting a position or movement of a finger in contact with said sensor operating panel; and
a display comprising a two-digit value with units-places and tens-places,
wherein said operating device is configured for setting said two-digit value with units-places and tens-places for a function parameter for a function device at said operating device, said operating device further configured for operating said function device, wherein said sensor operating panel detects and evaluates movements independently of one another of said finger in proximity or in contact in two operating directions being substantially perpendicular to one another,
wherein said operating device is configured to detect a movement of said finger on said sensor operating panel in a first operating direction and in a second operating direction, wherein said second operating direction is substantially perpendicular to said first operating direction,
set said units-places value at said operating device based on evaluating said movement of said finger in said first operating direction, and
set said tens-places value at said operating device independently of said movement of said finger in said first operating direction based on said movement of said finger in said second operating direction.

11. The device according to claim 10, wherein said sensor operating panel is rectangular and sensors are arranged at least in all corner areas or underneath it.

12. The device according to claim 10, wherein said sensors are pressure sensors.

13. The device according to claim 10, wherein said sensors are capacitive sensors, wherein a covering surface of said sensor operating panel is electrically non-conductive.

14. The device according to claim 10, wherein said sensors are optical sensors and said sensor operating panel is optically translucent for light in a certain wavelength which is an operating wavelength of the sensors.
